(19) United States
(12) Patent Application Publication
(10) Pub. No.: US 2015/0377108 A1
(43) Pub. Date: Dec. 31, 2015

(54) DUAL FUEL ENGINE SYSTEM

(71) Applicant: Caterpillar Inc., Peoria, IL (US)

(72) Inventors: Scott B. Fiveland, Metamora, IL (US); Douglas A. Rebinsky, Peoria, IL (US); Matthew T. Wolk, Peoria, IL (US)

(73) Assignee: Caterpillar Inc., Peoria, IL (US)

(21) Appl. No.: 14/845,352

(22) Filed: Sep. 4, 2015

(51) Int. Cl. F01N 3/26; F02M 43/00; F02M 25/07; F02B 37/20

(52) U.S. Cl. CPC F01N 3/26; F02B 37/20; F02M 43/00; F02M 25/0706

(57) ABSTRACT

A dual fuel engine system is provided. The dual fuel engine system includes a dual fuel engine. The dual fuel engine system also includes a turbocharger connected to the dual fuel engine having a turbine portion and a compressor portion. The dual fuel engine system further includes a methane reduction module positioned downstream of the turbocharger. The methane reduction module is configured to receive a flow of exhaust gas from the turbine portion of the turbocharger. The methane reduction module includes a combustor. The methane reduction module is adapted to increase a temperature of the exhaust gas flow received from the turbine portion of the turbocharger. The methane reduction module is also adapted to combust methane constituents present in the exhaust gas based on the increase in the temperature.

### TECHNICAL FIELD

The present disclosure relates to a dual fuel engine system, and more particularly to treatment of exhaust gas of the dual fuel engine system.

### BACKGROUND

Due to incomplete burning of fuel, methane is present as a by-product in exhaust gases exiting a dual fuel engine. Methane is inherently very difficult to oxidize due to its short chain hydrocarbon structure. Methane present in the exhaust gases must be oxidized before being let out in the atmosphere as methane is a greenhouse gas contributor.

The exhaust gases exiting an engine of the engine system is provided to a turbocharger in order to provide driving power to the turbocharger. In present engine systems, a catalyst is provided downstream of the turbocharger for conversion of the methane in the exhaust gases. However, a temperature of the exhaust gases at the exit of the turbocharger does not allow efficient conversion of the methane. Due to the poor conversion efficiency, a high amount of methane may still be present in the exhaust gases. Conventional methods may result in conversion efficiencies of approximately 35% or less.

U.S. Published Application No. 2010/0077998, hereinafter referred to as '998 publication, describes a turbocharged engine. The turbocharger engine includes an internal combustion engine and a turbocharger powered by engine exhaust flow from the internal combustion engine to supply the engine with compressed intake air. The turbocharged engine further includes a turbocharger booster system with a dry low emissions burner. The burner fluidly communicates with an exhaust manifold of the engine and is operable to inject a combustion gas flow into the engine exhaust flow. The hot combustion gas flow is operable to increase the exhaust energy available to the turbocharger and thereby increase the output of compressed intake air. However, the '998 publication does not describe a solution to improve conversion efficiency of the unburned methane constituents of the exhaust.

### SUMMARY OF THE DISCLOSURE

In one aspect of the present disclosure, a dual fuel engine system is provided. The dual fuel engine system includes a dual fuel engine. The dual fuel engine system also includes a turbocharger connected to the dual fuel engine having a turbine portion and a compressor portion. The dual fuel engine system further includes a methane reduction module positioned downstream of the turbocharger. The methane reduction module is configured to receive a flow of exhaust gas from the turbine portion of the turbocharger. The methane reduction module includes a combustor. The methane reduction module is adapted to increase a temperature of the exhaust gas flow received from the turbine portion of the turbocharger. The methane reduction module is also adapted to combust methane constituents present in the exhaust gas based on the increase in the temperature.

Other features and aspects of this disclosure will be apparent from the following description and the accompanying drawings.

### BRIEF DESCRIPTION OF THE DRAWINGS

FIG. 1 is a schematic diagram of an exemplary dual fuel engine system, according to one embodiment of the present disclosure; and

FIG. 2 is an exemplary cross sectional view of a methane reduction module associated with the dual fuel engine system of FIG. 1, according to one embodiment of the present disclosure.

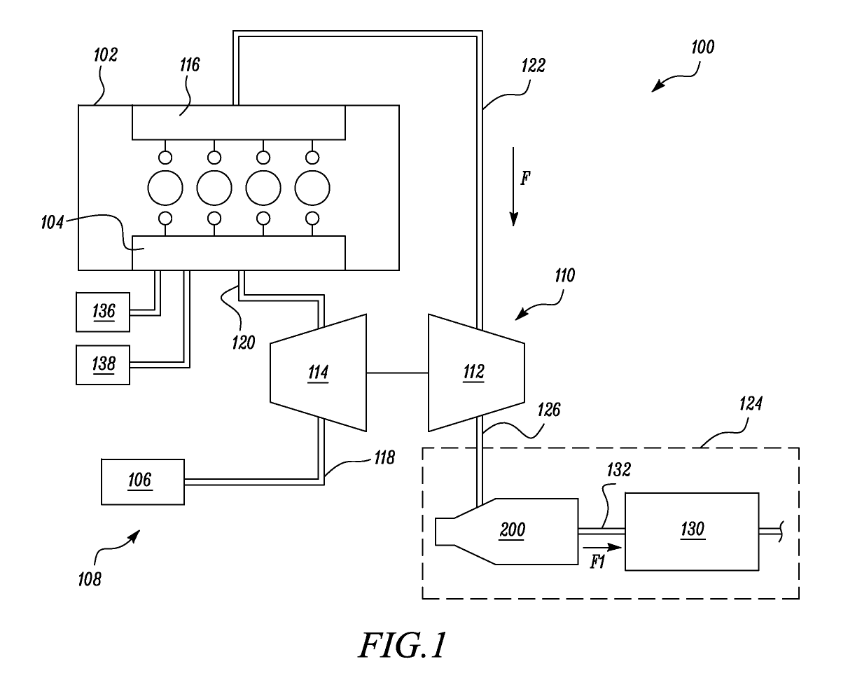

### DETAILED DESCRIPTION

Wherever possible, the same reference numbers will be used throughout the drawings to refer to the same or the like parts. Referring to FIG. 1, a schematic view of an exemplary engine system 100 is illustrated. The engine system 100 is embodied as a dual fuel engine system. In one example, the engine system 100 may embody a dynamic gas blending engine system. The engine system 100 includes an engine 102, which may be an internal combustion engine, such as, a reciprocating piston engine or a gas turbine engine. Alternatively, the engine 102 may be a spark ignition engine or a compression ignition engine. In one embodiment, the engine 102 is configured to combust a mixture of air, a liquid fuel such as diesel, and/or a gaseous fuel such as natural gas. The engine 102 may be fueled by one or more of gasoline, diesel fuel, biodiesel, dimethyl ether, alcohol, natural gas, propane, hydrogen, combinations thereof, or any other combustion fuel known in the art.

The engine 102 may include components (not shown), such as an engine block, a cylinder head, a plurality of cylinders, and the like. The engine 102 may be utilized for any suitable application such as motor vehicles, work machines, locomotives or marine engines, and in stationary applications such as electrical power generators.

Each cylinder of the engine 102 includes one or more intake valves (not shown). The intake valves may be configured to supply air for combustion with the fuels in the cylinder. An intake manifold 104 is formed or attached to the engine 102 such that the intake manifold 104 extends over or is proximate to each of the cylinders. Ambient air is drawn into the engine 102 through an air filter 106 of an air intake system 108. The air intake system 108 of the engine system 100 includes a turbocharger 110. The intake air is introduced into the turbocharger 110 via a conduit 118 for compression purposes leading to a higher pressure thereof. The compressed intake air then flows towards the intake manifold 104 of the engine 102, via a conduit 120. The turbocharger 110 includes a turbine portion 112 and a compressor portion 114. One or more turbines (not shown) present within the turbine portion 112 of the turbocharger 110 provides operating power to the turbocharger 110. The turbines are driven by exhaust gases exiting the engine 102. More particularly, the exhaust gases impart rotational energy to the turbines. Further, the compressor portion 114 includes a compressor (not shown). The compressor is configured to compress the intake air received therein. The turbines present in the turbine portion 112 may be coupled to the compressor via a shaft, so that the rotational energy of the turbines may be utilized to power the compressor.

In order to supply the liquid fuel to the engine 102 for combustion purposes, a liquid fuel system 136 is associated with the engine 102. The liquid fuel system 136 may include a fuel reservoir to store the fuel, such as the diesel fuel. The engine system 100 includes a natural gas system 138 operatively coupled with the engine 102. The natural gas system 138 introduces natural gas into the cylinders of the engine 102. The natural gas system may include a fuel reservoir to store the natural gas therein.

The engine system 100 further includes an exhaust manifold 116. Products of combustion are exhausted from the engine 102 via the exhaust manifold 116. The exhaust manifold 116 is in fluid communication with the turbine portion 112 via a conduit 122. Before exiting the engine system 100, the exhaust gases flow over the turbine provided in the turbine portion 112 of the turbocharger 110 in order to provide operating power to the turbocharger 110.

An exhaust gas flow “F” exiting the engine 102 contains emission compounds that may include oxides of nitrogen (NOx), unburned methane and other unburned hydrocarbons, particulate matter, and/or other combustion products known in the art. In order to treat the exhaust gases after they exit the turbocharger 110 of the engine 102, an exhaust system 124 is associated with the engine system 100. The exhaust system 124 is configured to trap or convert NOx, methane, unburned hydrocarbons, particulate matter, combinations thereof, or other combustion products present in the exhaust gas flow “F”, before exiting the engine system 100.

The exhaust system 124 includes a methane reduction module 200. The turbine portion 112 of the turbocharger 110 is in fluid communication with the methane reduction module 200 via conduit 126. The methane reduction module 200 is provided downstream of the turbocharger 110 with respect to the exhaust gas flow “F”.

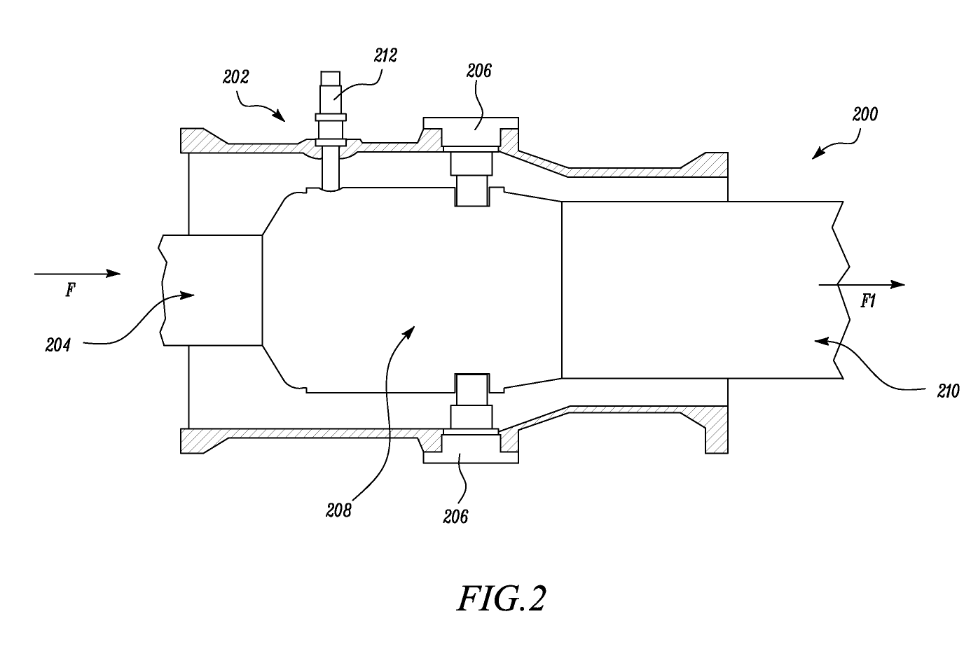

Referring to FIG. 2, the methane reduction module 200 includes a combustor 202. The combustor 202 may embody any known burner configured to ignite or combust the exhaust gases received therein. The combustor 202 includes an inlet 204. The inlet 204 is in fluid communication with the conduit 126 and is configured to receive exhaust gases therefrom. Further, a pair of injectors 206 extends into a combustion space 208 of the combustor 202. The injectors 206 are configured to receive a fuel, such as diesel or natural gas from the respective liquid fuel system or the natural gas system of the engine system 100. The fuel is introduced into the combustion space 208 of the combustor 202 in order to ignite and increase a temperature of the exhaust gases flowing therethrough. Based on system requirements, diesel or natural gas in the range of approximately 2% to 10% may be introduced into the combustion space 208. The combustor 202 also includes an igniter 212. The igniter 212 is configured to ignite the exhaust gases within the combustion space 208 after the fuel in injected therein.

Further, the increase in temperature due to the combustion of the exhaust gases causes combustion of at least a portion of methane constituents present in the exhaust gases. The combusted exhaust gases having the increased temperature exits the combustor 202 via an outlet 210. It should be noted that the engine system 100 may include suitable arrangements to couple the liquid fuel system or the natural gas system with the injector 206 of the methane reduction module 200.

The combusted exhaust gases exiting the combustor 202 are generally at a very high temperature due to the combustion within the combustor 202. Additionally or optionally, referring to FIG. 1, the engine system 100 includes an energy recovery means 130 to extract the energy of the combusted exhaust gases exiting the combustor 202. The energy recovery means 130 is coupled with the outlet 210 of the combustor 202 via a conduit 132. The exhaust gases flow through the energy recovery means 130 for extraction of energy from the exhaust gases. For example, a mechanical equipment may be provided downstream of the combustor 202 with respect to a flow “F1” of the combusted exhaust gases.

In one example, the mechanical equipment may embody a turbomachinery. The turbomachinery may include any one of a mechanical turbo compound, a turboalternator, and the like. Alternatively, any other energy recovery means 130 may be provided in communication with the outlet 210 of the combustor 202 in order to extract energy from the combusted exhaust gases. In an example wherein the energy recovery means 130 is the turboalternator, the power generated by the turboalternator may be used to provide electricity to accessories associated with a machine in which the engine system 100 is installed. It should be noted that the exhaust system 124 may include additional components other than those listed herein to treat the exhaust gases. The combusted exhaust gases exiting the exhaust system 124 may be released into the atmosphere.

### INDUSTRIAL APPLICABILITY

The present disclosure describes the engine system 100 having the methane reduction module 200. The methane reduction module 200 is configured to combust the exhaust gases received from the turbocharger 110 causing the temperature of the exhaust gases to increase. The increase in the temperature of the exhaust gases causes some portion of the methane constituents present in the exhaust gases to combust. Therefore, as compared to the exhaust gases at the inlet 204 of the methane reduction module 200, the exhaust gases at the outlet 210 of the methane reduction module 200 contains lower amount of methane constituents therein.

The addition of the methane reduction module 200 reduces the presence of the methane constituents in the exhaust gases that exit the engine system 100. Accordingly, the combusted exhaust gases exiting the engine system 100 are substantially free of any unburned hydrocarbons.

Further, the engine system 100 disclosed herein also includes means to extract energy from the high temperature combusted exhaust gases exiting the methane reduction module 200. The energy could be extracted across any mechanical element, such as turbomachinery, to power associated components of the machine.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A dual fuel engine system comprising:
a dual fuel engine;
a turbocharger connected to the dual fuel engine having a turbine portion and a compressor portion;
a methane reduction module positioned downstream of the turbocharger, the methane reduction module configured to receive a flow of exhaust gas from the turbine portion of the turbocharger, the methane reduction module including a combustor, wherein the methane reduction module is adapted to:
increase a temperature of the exhaust gas flow received from the turbine portion of the turbocharger; and
combust methane constituents present in the exhaust gas based on the increase in the temperature.
